(19) United States
(12) Patent Application Publication
(10) Pub. No.: US 2024/0383417 A1
(43) Pub. Date: Nov. 21, 2024

(54) ONBOARD DESIGN DEVICE AND ONBOARD DESIGN METHOD

(71) Applicant: DENSO CORPORATION, Kariya-city (JP)

(72) Inventors: Ryota KAMEOKA, Kariya-city (JP); Takuro OMURA, Obu-city (JP); Hidetoshi MORITA, Kariya-city (JP)

(21) Appl. No.: 18/666,031

(22) Filed: May 16, 2024

(30) Foreign Application Priority Data
May 18, 2023 (JP) 2023-082277

(51) Int. Cl. B60R 16/023; B60R 11/00

(52) U.S. Cl. CPC B60R 16/0231; B60R 11/00; B60R 2011/0001

(57) ABSTRACT

An onboard design device or an onboard design method: acquires topology information indicating: a plurality of onboard candidate positions; at least one device onboard position showing a position of a peripheral device; and a wiring route; acquires a coefficient that defines an onboard function and an onboard condition; and determines an onboard position and an onboard number of an electronic control unit.

### CROSS REFERENCE TO RELATED APPLICATION

The present application claims the benefit of priority from Japanese Patent Application No. 2023-082277 filed on May 18, 2023. The entire disclosure of the above application is incorporated herein by reference.

### TECHNICAL FIELD

The present disclosure relates to a technology for designing an onboard position of an in-vehicle electronic control unit.

### BACKGROUND

According to a method of a comparative example, an onboard position of a vehicle electronic control unit (hereinafter referred to as ECU) is determined. This method is based on the premise that the onboard positions of all ECUs required to achieve full specifications have been set in advance (In other words, an initial setting has been made in advance). Depending on the grade of the vehicle, when there is an empty onboard position where the ECU cannot be mounted, it is moved to the empty onboard position. Thereby, when there is an ECU for which a wire harness length can be shortened, the ECU is moved to the empty onboard position.

### SUMMARY

An onboard design device or an onboard design method: acquires topology information indicating: a plurality of onboard candidate positions; at least one device onboard position showing a position of a peripheral device; and a wiring route; acquires a coefficient that defines an onboard function and an onboard condition; and determines an onboard position and an onboard number of an electronic control unit.

### BRIEF DESCRIPTION OF THE DRAWINGS

FIG. 1 is a block diagram showing a configuration of an onboard design device for an in-vehicle electronic control unit.

FIG. 2 is a wire harness topology diagram showing an overview of topology information.

FIG. 3 is a table showing contents of the topology information.

FIG. 4 is a table showing contents of coefficient information.

FIG. 5 is an explanatory diagram showing a relationship between the presence or absence of a loop connection, the number of onboard nodes, and the number of links.

FIG. 6 is a flowchart of an onboard design process.

FIG. 7 is an explanatory diagram showing a relationship between the number of zone ECUs and the amount of wiring between the zone ECUs and peripheral devices.

FIG. 8 is a graph showing results of measuring a relationship between the number of onboard candidate positions of zone ECUs and a calculation time required for design for a method of the embodiment and a comparison method.

FIG. 9 is a graph showing results of calculating a total cost of design results for the method of the embodiment and the comparison method.

### DETAILED DESCRIPTION

As a result of the inventors' studies, it has been found that in the conventional technology, an initial setting of the ECU onboard position is not necessarily optimized. Further, in the conventional technology, a difficulty has been found in that a large number of design patterns cannot be evaluated based on factors other than the wire length of the wire harness.

One example of the present disclosure provides a technology for accurately determining an onboard position, in consideration of the number of onboard positions, in onboard position design of electronic control units.

According to one example embodiment of the present disclosure, an onboard design device includes: a topology information acquisition unit configured to acquire topology information indicating: a plurality of onboard candidate positions showing a position where an electronic control unit is mountable on a design target vehicle; at least one device onboard position showing a position where a peripheral device, which is mounted on the design target vehicle and connected to the electronic control unit, has been mounted; and a wiring route including a route between the plurality of onboard candidate positions and a route from the device onboard position to the plurality of onboard candidate positions; an onboard coefficient acquisition unit configured to acquire a coefficient that defines an onboard function and an onboard condition determined according to the design target vehicle, wherein the onboard function is an objective function used for calculating an evaluation value indicating whether an arrangement of the electronic control unit is desired, the onboard condition is a constraint that limits a range that a first decision variable and a second decision variable are capable of taking, the first decision variable represents whether to mount the electronic control unit for each of the plurality of onboard candidate positions, and the second decision variable represents a connection destination that is the electronic control unit mounted at the plurality of onboard candidate positions and connected for each peripheral device; and an onboard calculation unit configured to determine an onboard position and an onboard number of the electronic control unit by calculating the first decision variable and the second decision variable that maximize or minimize the evaluation value calculated by the onboard function in a range that satisfies the onboard condition.

According to such a configuration, it is possible to accurately determine the onboard position of the electronic control unit, in consideration of the number of onboard electronic control units. According to another example embodiment of the present disclosure, an onboard design method is performed by an onboard design device constructed using a computer, and the method includes causing: a topology information acquisition unit of the computer to acquire topology information regarding: a plurality of onboard candidate positions showing a position where an electronic control unit is mountable on a design target vehicle; at least one device onboard position showing a position where a peripheral device, which is mounted on the design target vehicle and connected to the electronic control unit, has been mounted; and a wiring route including a route between the plurality of onboard candidate positions and a route from the device onboard position to the plurality of onboard candidate positions; an onboard coefficient acquisition unit of the computer to acquire a coefficient that defines an onboard function and an onboard condition determined according to the design target vehicle, wherein the onboard function is an objective function used for calculating an evaluation value indicating whether an arrangement of the electronic control unit is desired, the onboard condition is a constraint that limits a range that a first decision variable and a second decision variable are capable of taking, the first decision variable represents whether to mount the electronic control unit for each of the plurality of onboard candidate positions, and the second decision variable represents a connection destination that is the electronic control unit mounted at the plurality of onboard candidate positions and connected for each peripheral device; and an onboard calculation unit of the computer to determine an onboard position and an onboard number of the electronic control unit by calculating the first decision variable and the second decision variable that maximize or minimize the evaluation value calculated by the onboard function in a range that satisfies the onboard condition.

According to such a method, it is possible to obtain the same effects as the above-described onboard design device.

Hereinafter, embodiments of the present disclosure will be described with reference to drawings.

### 1. First Embodiment

### 1-1. Configuration

An onboard design device 1 of an in-vehicle electronic control unit (hereinafter referred to as ECU) according to a first embodiment is used for designs of the number of onboard zone ECUs and onboard positions of the zone ECUs, and also used for designs of a wiring structure of a power line that connects the zone ECUs in a vehicle that adopts a zone architecture.

The zone architecture is a type of electrical/electronic architecture (i.e., EEA) of a vehicle. The current mainstream of EEA is a domain distributed architecture. In the domain distributed architecture, a plurality of ECUs are arranged for each specific system (i.e., domain) such as a power train, body, chassis, and the like. In contrast, the zone architecture consolidates control functions and information into a small number of computers called zone ECUs having high processing power. This enables a simple wiring structure and more efficient system development.

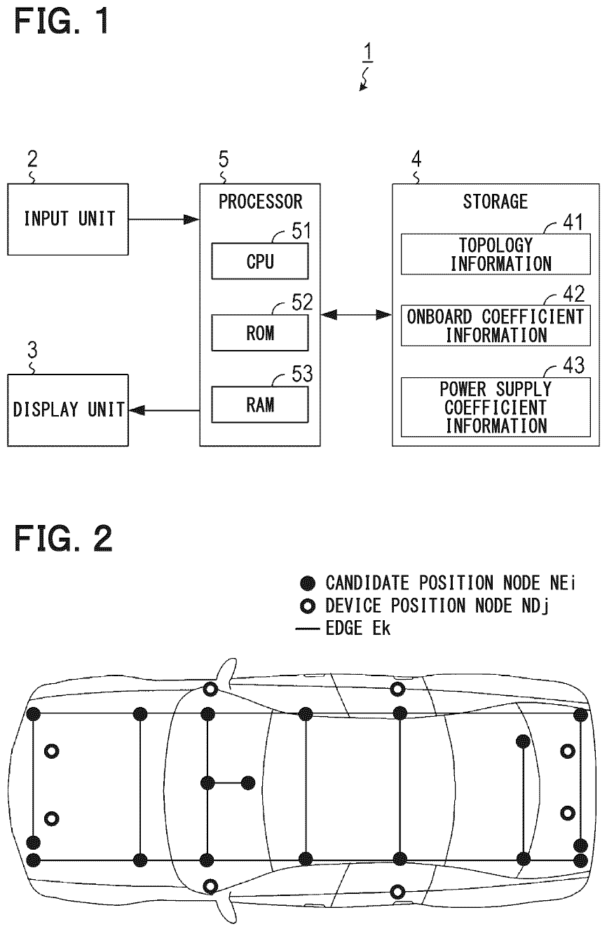

As shown in FIG. 1, the onboard design device 1 includes an input unit 2, a display unit 3, a storage 4, and a processor 5. The input unit 2 includes a keyboard, a pointing device, and the like, and is used to input various commands and various information for operating the onboard design device 1. The input unit 2 may include a communication interface for communicating with other devices (for example, a server) directly or via a network, a reading device for reading information from various re media, and the like. The input unit 2 may be configured to input necessary information via the communication interface and the reading device.

The display unit 3 includes, for example, a liquid crystal display, and has an information input screen for inputting various information via the input unit 2, a result presentation screen for presenting processing results in the processor 5, and the like. The input unit 2 and the display unit 3 may be integrally configured using a display with a touch panel or the like.

The storage 4 includes a storage medium such as a hard disk or a USB memory. The storage 4 stores various information necessary for processes by the processor 5. The information stored in the storage 4 may be acquired from the outside via the input unit 2 or may be updated. When the storage 4 includes a removable storage medium, the information may be updated by replacing the storage medium.

The processor 5 includes a CPU 51, a ROM 52, and a RAM 53. Various functions of the processor 5 are implemented by the CPU 51 executing programs stored in a non-transitional tangible storage medium. In the present embodiment, the ROM 52 corresponds to a non-transitory tangible storage medium storing programs. By executing the program, a method corresponding to the program is executed. The processor 5 at least executes a onboard design process for designing the number of onboard zone ECUs, their onboard positions, and the wiring structure of power lines connecting the zone ECUs.

### 1-2. Information in Storage

The storage 4 stores at least topology information 41, onboard coefficient information 42, and power supply coefficient information 43.

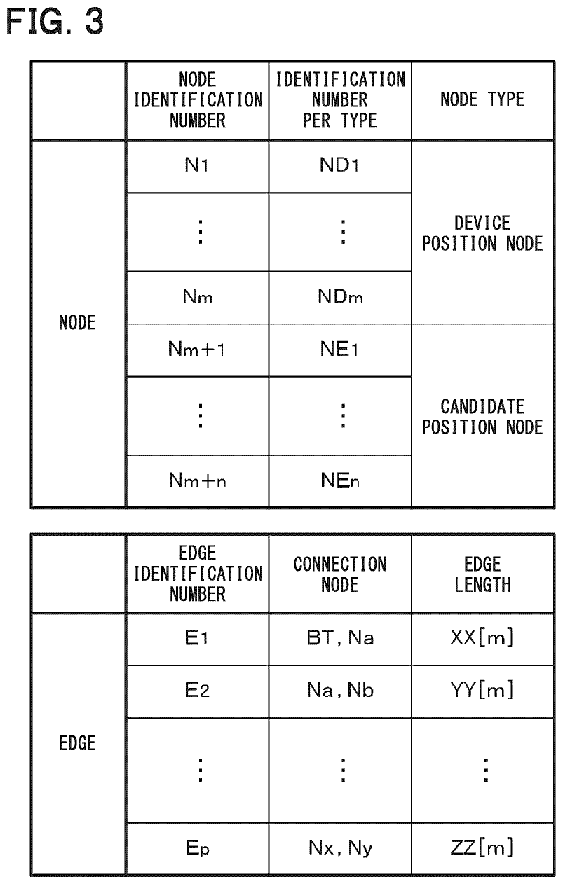

The topology information 41 is prepared for each type of vehicle. As shown in FIG. 2, the topology information 41 has a graph-type data structure expressed by a graph defined by a plurality of nodes and a plurality of edges connecting the nodes. As shown in FIG. 3, nodes N1 to Nₘ₊ₙ have m device position nodes ND₁ to NDₘ and n candidate position nodes NE₁ to NEₙ. The m and n are arbitrary positive integers. Hereinafter, when the individual nodes N₁ to Nₘ₊ₙ are not particularly distinguished, they will be referred to as nodes N. When the individual device position nodes ND₁ to NDₘ are not particularly distinguished, they are referred to as device location nodes ND. When the individual candidate position nodes NE₁ to NEₙ are not particularly distinguished, they are referred to as candidate position nodes NE.

The device position node ND represents the position where the peripheral device DV is mounted in the vehicle (hereinafter referred to as device onboard position). The peripheral devices DV are sensors, actuators, and the like connected to the zone ECU. The candidate position node NE represents a position in the vehicle where the zone ECU is mountable (hereinafter referred to as a onboard candidate position). The topology information 41 includes, as information, the number m of device position nodes ND (i.e., the device onboard position and peripheral devices mounted at the device onboard position), and the number n of candidate position nodes NE (i.e., onboard candidate positions).

Edges E₁ to Eₚ are information representing wiring routes connecting the nodes N. Hereinafter, individual edges E₁ to Eₚ will be referred to as edges E unless they are particularly distinguished. The edge E is set to form the following graph. Each device position node ND has one or more edges E that reach any of the candidate position nodes NE. Each candidate position node NE has one or more edges E leading to other candidate position nodes NE. One of the candidate position nodes NE includes a battery BT as a connection node. However, in FIG. 2, only the edge E connecting the candidate position nodes NE is shown. The edge E connecting the candidate position node NE and the device position node ND, and the edge E connecting the candidate position node NE and the battery BT are omitted in FIG. 2.

As shown in FIG. 3, each edge E has information about connection nodes and edge length. The connection node is information that identifies the node N connected to both ends of the edge E. The edge length is information representing the length of the wiring route corresponding to the edge E on the vehicle.

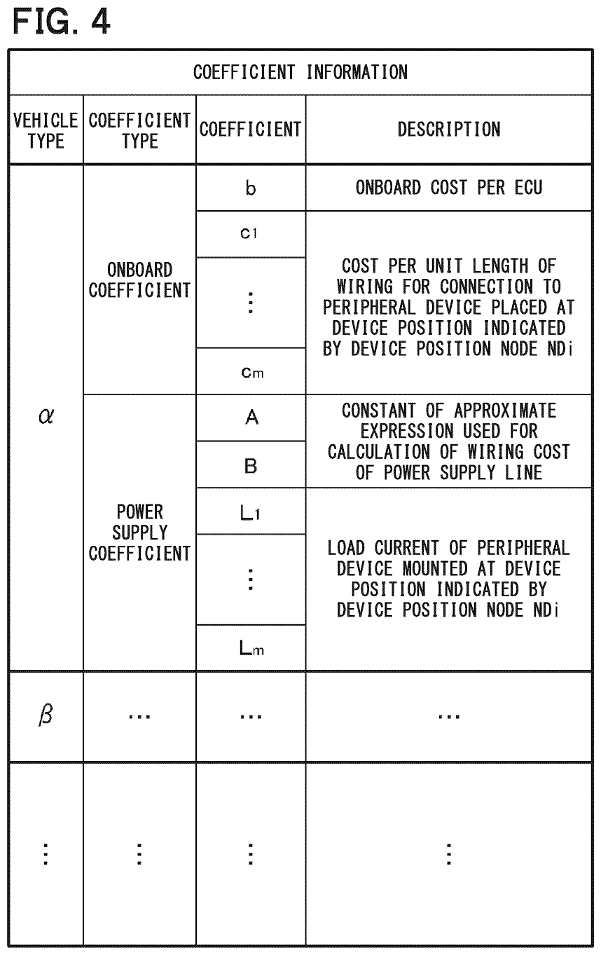

As shown in FIG. 4, the onboard coefficient information 42 and the power supply coefficient information 43 are prepared for each type of vehicle. The onboard coefficient information 42 includes a plurality of onboard coefficients used to define onboard functions and onboard conditions. A onboard function is an objective function used to determine which onboard candidate position (i.e., candidate position node NE) to mount the zone ECU. The onboard condition is a constraint used to define the range of values that decision variables used in the onboard function are capable of taking.

The power supply coefficient information 43 includes a plurality of power supply coefficients used to define a power supply function and a power supply condition. The power supply function is an objective function used to determine the wiring structure of power lines between zone ECUs whose onboard positions and number of onboard ECUs have been determined according to the onboard function and onboard conditions. The power supply condition is a constraint used to limit the range of values that the decision variables used in the power supply function are capable of taking. The objective function and constraints are expressed by equations or inequalities using decision variables and onboard coefficients or power supply coefficients.

The onboard coefficients include at least onboard cost b and device wiring cost cᵢ. The onboard cost b is the cost per zone ECU that is required by mounting the zone ECU on a vehicle. The device wiring cost cᵢ is the cost per unit length of wiring required for connection to the peripheral device DVᵢ mounted at the position indicated by the device position node NDᵢ.

The power supply coefficients include at least constants A, B, and device load current Lk. The constants A and B are used in an approximate expression for calculating the power line wiring cost Cᵢ. The power line wiring cost Cᵢ is the cost per unit length of the power line used to supply power to the zone ECU that has been determined to be mounted at the onboard candidate position indicated by the candidate position node NEi. A device load current Lᵢ is the load current of the peripheral device DVᵢ mounted at the position indicated by the device position node NDᵢ.

### 1-3. Objective Function and Constraints

The onboard function and the onboard condition used by the processor 5 for designs of the onboard positions and the number of onboard zone ECUs will be described.

The onboard function is expressed by a first equation.

$$min Z = b {\sum }_{j = 1}^{n} {x}_{j} + {\sum }_{i = 1}^{m} {\sum }_{j = 1}^{n} {c}_{i} {d}_{i j} {y}_{i j} \qquad ( First Equation )$$

In the first equation, Z is an evaluation value. In the first equation, the xⱼ and yᵢⱼ are decision variables. A case of xⱼ=1 means that the zone ECU is mounted at the onboard candidate position indicated by the candidate position node NEⱼ. A case of xⱼ=0 means that the zone ECU is not mounted at the onboard candidate position indicated by the candidate position node NEⱼ. Hereinafter, the zone ECU mounted at the onboard candidate position indicated by the candidate position node NEⱼ will be referred to as an onboard ECUⱼ. A case of yᵢⱼ=1 means that the peripheral device DVᵢ placed at the device onboard position indicated by the device position node NDᵢ is connected to the onboard ECUj. A case of yᵢⱼ=0 means that the peripheral device DVᵢ is not connected to the onboard ECUj.

In the first equation, the dᵢⱼ represents a wiring route length from the device position node NDᵢ to the candidate position node NEⱼ, that is, the length of the signal line required to connect the peripheral device DBᵢ and the onboard ECUⱼ. The wiring route length dᵢⱼ is calculated based on the edge length included in the topology information 41 by summing the edge lengths of all edges belonging to the shortest route from the device position node NDᵢ to the candidate position node NEⱼ. For example, Dijkstra's algorithm, which is an algorithm used in graph theory, can be used to calculate the wiring route length dᵢⱼ. Note that the wiring route length dᵢⱼ may be a value calculated in advance for each of all combinations of the device position node NDᵢ and the candidate position node NEⱼ. When the wiring route length dᵢⱼ is calculated in advance, the wiring route length dᵢⱼ may be included in the topology information 41.

In the first equation, the m is the number of peripheral devices DV (i.e., device position nodes ND), and the n is the number of onboard candidate positions (i.e., candidate position nodes NE), both of which are included in the topology information 41.

In the first equation, the b is the onboard cost per zone ECU, and the cᵢ is the wiring cost per unit length to the peripheral device DVᵢ, both of which are included in the onboard coefficient information 42.

In the first equation, the first term on the right side is the total value (hereinafter referred to as total onboard cost) of onboard costs determined by the number of onboard zone ECUs. Further, in the first equation, the second term on the right side is the total value (hereinafter referred to as total wiring cost) of the wiring cost between the zone ECU and each peripheral device DV, the cost being determined by the onboard positions of the zone ECUs. That is, the first equation means that the evaluation value Z is the total of the total onboard cost and the total wiring cost, and the values of the decision variables xⱼ and yᵢⱼ are determined so that the evaluation value Z is minimized. In this case, the quality of the design is determined based on the evaluation value Z, and it is determined that the smaller the evaluation value Z is, the better the design is. The better design may be also referred to as a desired design.

The onboard conditions applied to the onboard function are expressed by second and fourth expressions and a third equation

$${\sum }_{j = 1}^{n} {x}_{j} \geq 1 \qquad ( Second Expression )$$

$$\begin{matrix}{\sum }_{j = 1}^{n} {y}_{i j} = 1 & ∀ i\end{matrix} \qquad ( Third Equation )$$

$$\begin{matrix}{x}_{j} \geq {y}_{i j} & ∀ i , j\end{matrix} \qquad ( Forth Expression )$$

The onboard conditions expressed by the second to fourth equations are conditions that limit the range of values that the decision variables xⱼ and yᵢⱼ are capable of taking. The second expression represents a condition that the zone ECU must be mounted at one or more of the onboard candidate positions indicated by candidate position nodes NE₁ to NEₙ (in other words, one or more of x₁ to xₙ takes a value of 1).

The third equation represents a condition that all peripheral devices DV₁ to DVₘ must be connected to any one onboard ECUj (in other words, only one of yᵢ₁ to yᵢₙ takes a value of 1).

The fourth expression represents a condition that a connection destination of the peripheral device DVᵢ is limited to the onboard ECUj (in other words, the candidate position node NEⱼ where xⱼ=1). That is, the candidate position node NEⱼ in which no zone ECU is mounted (i.e., xj=0) does not become the connection destination of the peripheral device DVᵢ (i.e., yᵢⱼ=0 always).

Next, the power supply function and power supply conditions will be described, and are used by the processor 5 to determine the power line connection structure between the zone ECUs whose onboard number and onboard position have been determined using the onboard function. Next, the power supply function is defined by fifth to eighth equations.

$$min Z = {\sum }_{i = 1}^{m} {\sum }_{j = 1}^{n} {X}_{i j} {D}_{i j} {C}_{j} \qquad ( Fifth Equation )$$

$$\begin{matrix}{C}_{i} = A {e}^{{Bt}_{i}} & ∀ i\end{matrix} \qquad ( Sixth Equation )$$

$${t}_{i} = {\sum }_{k = 1}^{n} {Y}_{i k} {r}_{k} ∀ i \qquad ( Seventh Equation )$$

$$\begin{matrix}{r}_{k} = {\sum }_{i = 1}^{m} {y}_{i k} \cdot {L}_{i} & ∀ k\end{matrix} \qquad ( Eigth Equation )$$

In the fifth equation, the Xᵢⱼ is a decision variable. Hereinafter, the zone ECU that has been determined to be mounted at the onboard candidate position indicated by the candidate position node NEᵢ will be referred to as an onboard ECUᵢ. A case of Xᵢⱼ=1 means that the power line is connected from the onboard ECUᵢ to another onboard ECUⱼ. A case of Xᵢⱼ=0 means that the power line is not connected from the onboard ECUᵢ to the onboard ECUⱼ. In other words, the decision variable Xᵢⱼ indicates the presence or absence of connection including a connection direction in which the onboard ECUᵢ is the upstream power supply source and the onboard ECUj is the downstream power supply destination.

In the fifth equation, the Dᵢⱼ is the length of the wiring route from the candidate position node NEᵢ to the candidate position node NEⱼ, that is, the length of the wiring required to connect the onboard ECUi and the onboard ECUj. The wiring route length Dᵢⱼ is obtained by calculating the total of the edge lengths of all edges belonging to the shortest route from the candidate position node NEᵢ to the candidate position node NEⱼ, based on the edge length included in the topology information 41, as in the case of the wiring route length dᵢⱼ. For calculation of the wiring route length Dᵢⱼ, for example, Dijkstra's method or the like can be used as in the case of the wiring route length dᵢⱼ. The wiring route length Dᵢⱼ may be a value calculated in advance for each of all combinations of the candidate position node NEᵢ and the candidate position node NEⱼ. When the wiring route length Dᵢⱼ is calculated in advance, the wiring route length Dᵢⱼ may be included in the topology information 41.

In the fifth equation, the Cᵢ represents the wiring cost per unit length of the power line that supplies power to the onboard ECUi. The wiring cost Cᵢ is calculated for each onboard ECUi according to the sixth equation. In the sixth equation, the tᵢ represents the input current required by the onboard ECUi. The input current tᵢ is calculated for each onboard ECUi according to the seventh equation.

In the seventh equation, the Yᵢⱼ is a variable representing whether the onboard ECUi is an ancestor node of the onboard ECUj in the power line wiring structure designed to have a tree structure. A case of Yᵢⱼ=1 means that the onboard ECUi is the ancestor node of the onboard ECUj. A case of Yᵢⱼ=0 means that the onboard ECUi is not the ancestor node of the onboard ECUj. The ancestor nodes are all the onboard ECUs located closer to the battery BT (i.e., the power supply source) than the focused onboard ECU on the path from the battery BT to the focused onboard ECU. The Yᵢⱼ is calculated using constraints shown in an eleventh expression and a twelfth equation described later, and its value is determined according to the setting of the decision variable Xᵢⱼ.

In the seventh equation, the rₖ represents the load current supplied by the onboard ECUk to the peripheral device DV connected to itself. The load current rₖ is calculated for each onboard ECUi according to the eighth equation. In the eighth equation, the yᵢₖ is the decision variable determined using the first equation, and a case of yᵢₖ=1 means that the onboard ECUk is the connection destination of the peripheral device DVᵢ. A case of yᵢₖ=0 means that the onboard ECUk is not a connection destination of the peripheral device DVᵢ. In the eighth equation, the Lᵢ is the load current of the peripheral device DVᵢ, and is included in the power supply coefficient information 43. That is, the rₖ is calculated by summing the load currents Lᵢ of all peripheral devices DVᵢ connected to the onboard ECUk (i.e., yᵢₖ=1).

The fifth to eighth equations represent calculating the decision variable Xᵢⱼ that minimizes the evaluation value Z, with the evaluation value Z being the total wiring cost of the power lines connecting between the onboard ECUs. However, the wiring cost Cᵢ per unit length of the power line that supplies power to the onboard ECUi is set according to the input current tᵢ that is the total of the load currents rₖ of all the onboard ECUk whose ancestor node is the onboard ECUi (i.e., Yᵢₖ=1).

Next, the power supply conditions applied to the power supply function are defined by ninth and twelfth equations and tenth and eleventh expressions.

$${\sum }_{i = 1}^{n} {X}_{i j} = \{ \begin{matrix}0 ( j = g ) \\ 1 ( j \neq g )\end{matrix} ∀ j \qquad ( Ninth Equation )$$

$${\sum }_{i ∈ S} {\sum }_{j ∈ S} {X}_{ij} \leq \vert S \vert - 1 ( S ⊂ \{ 1 , … , n \} , 1 \leq \vert S \vert \leq n ) \qquad ( Tenth Expression )$$

$$\begin{matrix}{Y}_{i j} \geq {X}_{i j} & ∀ i , j\end{matrix} \qquad ( Eleven Expression )$$

$${Y}_{i j} = \{ \begin{matrix}1 \\ min ( {\sum }_{k = 1}^{n} {Y}_{i k} {Y}_{kj} , 1 ) \begin{matrix}( i \neq j ) \\ ( i = j )\end{matrix} ∀ i , j\end{matrix} \qquad ( Twelfth Equation )$$

The power supply conditions expressed by the ninth and twelfth equations and tenth and eleventh expressions represent a range that the decision variable Xᵢⱼ is capable of taking, the ancestor between the two onboard ECUs, and constraints on the value of Yᵢⱼ that defines whether there is an ancestor-descendant relationship.

The ninth expression and tenth equation represent conditions for making the tree structure between the onboard ECUs. The ninth equation represents the condition that the leading ECU does not have an input from a non-leading ECU, and that each non-leading ECU always has one input from another non-leading ECU other than itself. The leading ECU is the onboard ECUj that is directly connected to the battery BT and positioned at the most upstream position in the tree structure, where a relation of j=g is set. The non-leading ECU is the onboard ECUj other than the leading ECU, where a relation of j≠g is set.

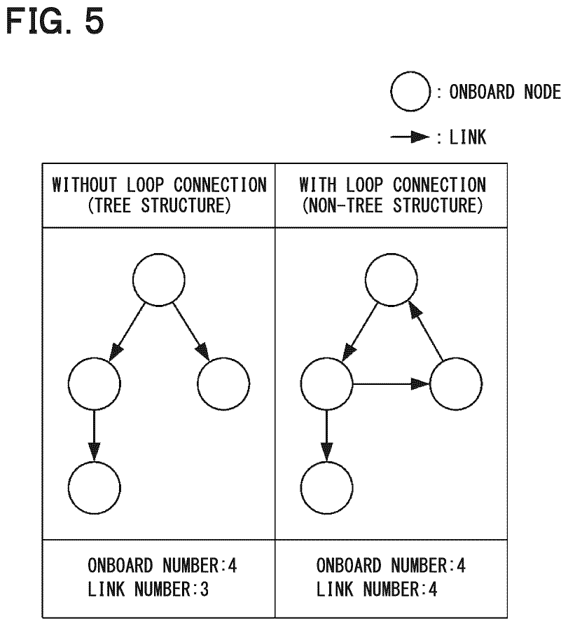

The tenth expression is a constraint for preventing loop connections from occurring in the connection structure between onboard ECUs. Specifically, when a subset of onboard ECUs is arbitrarily selected, the number of connections between installed ECUs included in that subset (hereinafter referred to as the number of links) is less than the number of onboard ECUs (hereinafter referred to as the number of nodes). As shown in FIG. 5, it can be understood that in a subset including a loop connection in the power line connection structure, the number of links is equal to or greater than the number of nodes. This relationship is used to eliminate connection structures that include loop connections.

The eleven expression and twelfth equation are constraints for defining the ancestor-descendant relationship between the onboard ECUi and the onboard ECUj, that is, the relationship between the power supply source (i.e., upstream) and the power supply destination (i.e., downstream).

The eleventh equation is a constraint that defines the basic relationship between a parent (i.e., ancestor) and a child (i.e., descendant). For example, a case of a connection where the onboard ECUi is upstream and the onboard ECUj is downstream (i.e., in the case of Xᵢⱼ=1) means that the onboard ECUi is defined to be the ancestor of the onboard ECUj (i.e., Yᵢⱼ=1).

In the twelfth equation, in a case of i=j, the equation means that all onboard ECUs define themselves as their own ancestors. In the twelfth equation, in a case of i≠j, the equation is a constraint on the relationship between ancestors and descendants of two or more generations, such as grandfather and grandchild. In other words, when the onboard ECUi is defined to be the ancestor of the onboard ECUk (i.e., Yᵢₖ=1) and the onboard ECUk is defined to be the ancestor of the onboard ECUj (i.e., Yₖⱼ=1), the onboard ECUi is the ancestor of the onboard ECUj (i.e., Yᵢⱼ=1).

In addition, in the twelfth equation, the reason, why the ancestor-descendant relationship is defined so that the onboard ECU includes itself in the ancestor node, is that when calculating the input current tᵢ of the onboard ECU using the seventh equation, its own load current rᵢ is included in the input current tᵢ.

### 1-4. Process

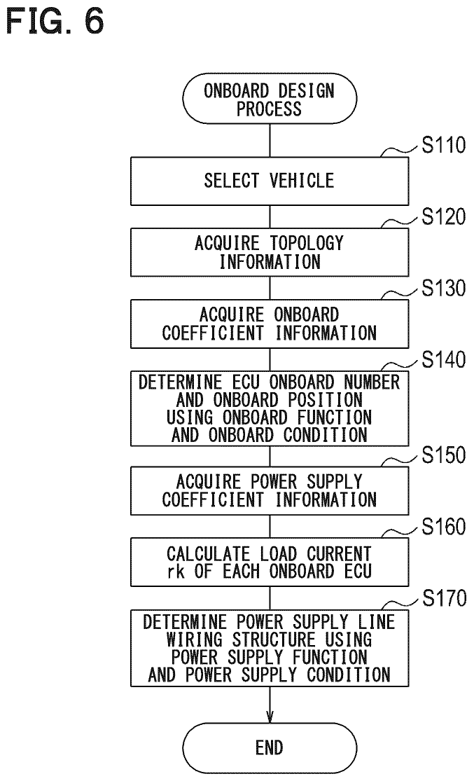

Next, the onboard design process executed by the processor 5 will be described with reference to a flowchart of FIG. 6. The ROM 52 of the processor 5 stores a design processing program that is a program for implementing an onboard design process. The onboard design process starts when a predetermined activation command is input via the input unit 2.

When the onboard design process starts, in S110, the processor 5 selects a vehicle to be designed. Specifically, a vehicle selection screen is displayed on the display unit 3, and the vehicle selected via the input unit 2 is set as the design target vehicle.

In subsequent S120, the processor 5 acquires topology information 41 regarding the design target vehicle from the storage 4. In subsequent S130, the processor 5 acquires the onboard coefficient information 42 regarding the design target vehicle from the storage 4.

In subsequent S140, the processor 5 applies the topology information 41 and the onboard coefficient information 42 acquired in S120 and S130 to the onboard function shown in the first equation and the onboard conditions shown in the second and fourth expressions and the third equation. Then, the processor 5 finds a combination of the first decision variable xᵢ and the second decision variable yᵢⱼ that minimizes the evaluation value Z calculated by the onboard function within a range that satisfies the onboard condition. This determines the number of onboard zone ECUs and the onboard positions. Note that the mathematical models shown in the first and third equations and the second and fourth expressions are classified as a mixed integer linear programming problem MILP. This refers to, among optimization problems (that are, a linear programming problems) in which the objective function and constraints are expressed linearly, a problem including variables that must be integers. A mathematical programming solver, which is software equipped with an algorithm for solving mathematical programming problems, is used to search for a combination of the decision variables xᵢ, yᵢⱼ that minimize the onboard function under onboard conditions. There are various mathematical programming solvers, and for example, Gurobi Optimizer can be used. Gurobi Optimizer is a registered trademark.

In subsequent S150, the processor 5 acquires the power supply coefficient information 43 regarding the design target vehicle from the storage 4. In subsequent S160, the processor 5 calculates the load current rₖ for each onboard ECUk using the eighth equation based on the calculation result in S140 and the power supply coefficient information 43 acquired in S150.

In the subsequent S170, the processor 5 applies the calculation result in S140 and the acquired power supply coefficient information 43 in S150 to the power supply functions shown in the fifth to seventh equations and the power supply conditions shown in the ninth and twelfth equations and tenth and eleventh expressions. Then, the processor 5 determines the wiring structure of the power line connecting the zone ECUs by calculating a third decision variable that minimizes the evaluation value Z calculated by the power supply function within a range that satisfies the power supply condition, and ends the process. Note that in S170, as in S140, the mathematical programming solver is used to search for a combination of the decision variable Xᵢⱼ that minimizes the power supply function under the power supply condition.

### 1-5. Estimate

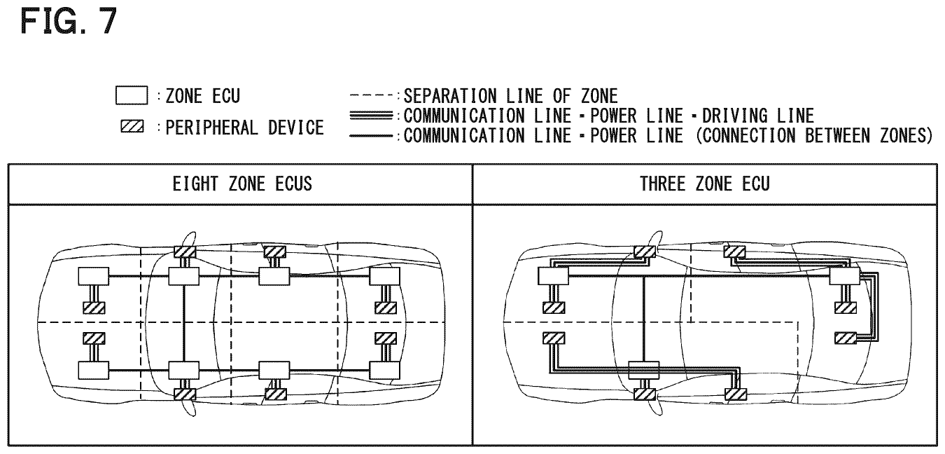

When implementing a zone architecture, it is necessary to design the number of onboard zone ECUs and the onboard positions of the zone ECUs in the vehicle. FIG. 7 illustrates a case where eight zone ECUs are mounted and a case where three zone ECUs are mounted. As shown in the figure, the more zone ECUs are added, the shorter the wiring required to connect peripheral devices and zone ECUs becomes. Conversely, the fewer the number of zone ECUs, the longer the wiring required to connect the peripheral devices and the zone ECUs. In other words, there is a trade-off relationship between the number of onboard zone ECUs and the amount of wiring.

There are a huge number of patterns for designing the number and position of onboard zone ECUs. For example, when there are 100 onboard candidate positions for the zone ECU, there are patterns for mounting/not mounting the zone ECU at each onboard candidate position. Therefore, the number of design patterns to be considered is 2¹⁰⁰.

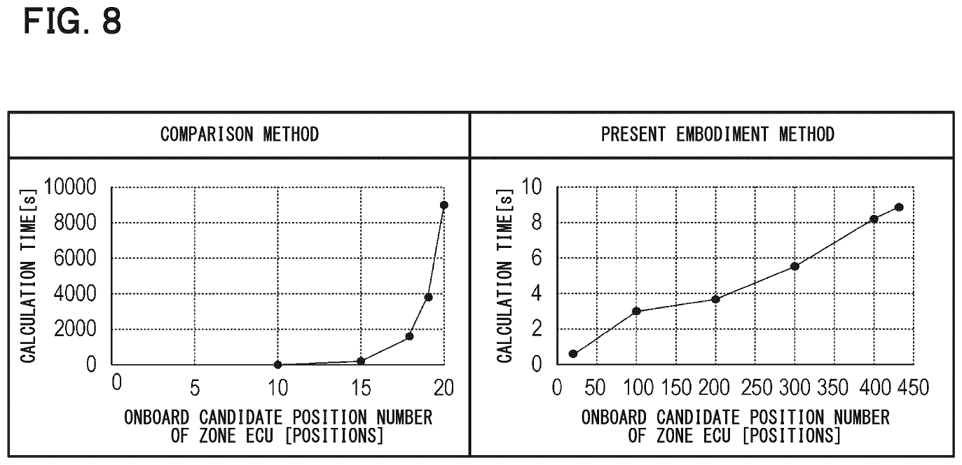

Here, FIG. 8 is a graph that shows a calculation time required for designs of a case of the method of the present embodiment (hereinafter referred to as the present method) using the number and positions of onboard zone ECUs and a case of a method (hereinafter referred to as a comparison method) that verifies all patterns in a brute force manner without defining a mathematical model. A computer with 6 Cores/12 Threads, a CPU operating at 32 GHZ, and a 32 GB main memory was used as a calculation environment.

In the comparison method, the calculation time increases exponentially with the number n of onboard candidate positions, and is about 9000 seconds when n=20. On the other hand, in the present method, the calculation time when n=20 is about 0.64 seconds, and the calculation is completed in less than 0.01% of the time of the comparison method. Further, in the present method, the increase in calculation time with respect to n is approximately linear, and even in a case of n=432, calculation is completed in 10 seconds or less. Note that n=432 is a value when all connectors existing in the EEA model used this time are set as onboard candidate positions. In other words, the present method can complete the design within a realistic amount of time even when there are a number of onboard candidate positions that are large enough for practical use.

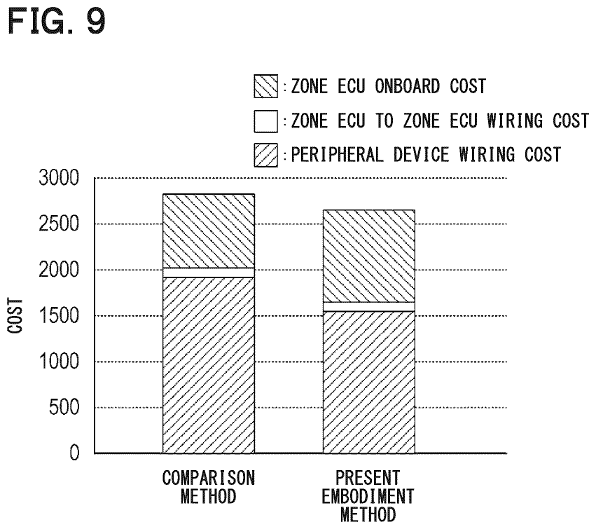

FIG. 9 shows the results of calculating the total onboard cost of zone ECUs, wiring costs between zone ECUs, and peripheral device wiring costs using the present method and the comparison method based on the results obtained in the design. In FIG. 9, the cost indicates the cost normalized by setting the cost per ECU to 100, which is necessary for mounting the ECU.

However, in the comparison method, the increase in the number n of onboard candidate positions for the zone ECU makes it impossible to obtain results within a realistic time. Therefore, n=20 is set. In this method, n=432, which is the upper limit in the EEA model described above, is set. Both methods uses the same data except for the onboard candidate position of the zone ECU.

As shown in FIG. 9, the total cost based on the design using the comparison method is 2824.1, and the total cost based on the design using the method of the present embodiment is 2637.5. It was confirmed that the cost was reduced by 6.6%.

The number of zone ECUs determined by design was 10 for the present method and 8 for the comparison method, and the onboard positions of the zone ECUs showed similar trends.

### 1-6. Correspondence of Terms

In the present embodiment, the processor 5 that executes the process of S120 corresponds to the topology information acquisition unit of the present disclosure. The processor 5 that executes the process of S130 corresponds to an onboard coefficient acquisition unit of the present disclosure. The processor 5 that executes the process of S140 corresponds to an onboard calculation unit of the present disclosure. Further, in the present embodiment, the processor 5 that executes the process of S150 corresponds to a power supply coefficient acquisition unit of the present disclosure. The processor 5 that executes the processes of S160 to S170 corresponds to a power supply calculation unit of the present disclosure. In the present embodiment, the onboard ECU corresponds to an onboard unit of the present disclosure. The leading ECU corresponds to a leading unit of the present disclosure. The non-leading ECU corresponds to a non-leading unit of the present disclosure.

### 1-7. Effects

According to a first embodiment described in detail above, the following effects are achieved.

(1a) The onboard design device 1 uses, as the decision variables of the onboard function which is the objective function, the xᵢ which determines whether to mount the zone ECU at each onboard position candidate, and the yᵢⱼ which determines whether to connect peripheral devices to each onboard position candidate. Accordingly, it is possible to perform a design that optimizes the onboard position of the zone ECU, including the number of onboard zone ECUs.

(1b) The onboard design device 1 uses the total value of the onboard cost of the zone ECU and the wiring cost between the onboard zone ECU and the peripheral device DV as the evaluation value calculated by the onboard function. In other words, not only the wiring cost but also the number of zone ECUs to be mounted can be correctly evaluated. Further, by appropriately changing the onboard function, it is possible to include various elements as evaluation targets.

(1c) In the onboard design device 1, the design of the onboard position of the zone ECU is regarded as an optimization problem. The objective function and constraints set using mathematical programming are used, and the solver searches for combinations of decision variables that minimize or maximize the objective function while satisfying the constraints. Accordingly, in the onboard design device 1, it is possible to significantly reduce the calculation time as compared to a method (i.e., a comparison method) of searching for an optimal design by exhaustively searching design patterns.

(1d) In the onboard design device 1, by expressing design constraints as mathematical programming constraints, it is possible to perform a design that takes various constraints into consideration.

(1e) In the onboard design device 1, the topology information 41 is expressed in the graph-type data structure, so by using the known method applied to graph-type data structures such as Dijkstra's algorithm, it is possible to further reduce the processing load.

### 2. Second Embodiment

### 2-1. Differences from First Embodiment

Since a basic configuration of a second embodiment is the same as that of the first embodiment, differences will be described below. The same reference numerals as in the first embodiment denote the same elements, and reference is made to the preceding description.

In the first embodiment described above, the evaluation value Z of the onboard function is the total of the onboard cost of the zone ECU and the wiring cost between the zone ECU and the peripheral device DV. On the other hand, the second embodiment differs from the first embodiment in that, in addition to the above-described onboard cost and wiring cost, the evaluation value Z is used that considers the weight of the wiring between the zone ECU and the peripheral device DV.

### 2-2. Onboard Function

In the second embodiment, an onboard function shown in a thirteen equation is used instead of the first equation.

$$min Z = ( b {\sum }_{j = 1}^{n} {x}_{j} + {\sum }_{i = 1}^{m} {\sum }_{j = 1}^{n} {c}_{i} {d}_{ij} {y}_{ij} ) {C}_{cost} + ( {\sum }_{i = 1}^{m} {\sum }_{j = 1}^{n} {w}_{i} {d}_{ij} {y}_{ij} ) {C}_{weight} \qquad ( Thirteenth Equation )$$

In the thirteenth equation, the wᵢ is the weight per unit length of the wiring required to connect the peripheral device DVᵢ. In the thirteenth equation, the C_{cost} is a coefficient that converts the total cost of onboard cost and wiring cost into an evaluation value.

In the thirteenth equation, the C_{weight} is a coefficient for converting the wiring weight into the evaluation value. Note that the wᵢ, the C_{cost}, and the C_{weight} are information included in the loading coefficient information 42.

That is, in the second embodiment, the weight addition value of the total cost and the wiring weight is used as the evaluation value Z.

### 2-3. Effects

The second embodiment described in detail above provides the effects (1a) through (1e) described in the first embodiment and the following effect in addition.

(2a) According to the second embodiment, it is possible to implement a design that considers the weight of wiring, which affects the total weight of the vehicle.

### 3. Other Embodiments

Although the embodiments of the present disclosure have been described above, the present disclosure is not limited to the above-described embodiments and can be implemented with various modifications.

(3a) In the second embodiment described above, by the onboard function, the evaluation is performed so as to include the wiring weight, but the power supply function may be used to perform the evaluation so that the wiring weight of the power line is included. Further, evaluation elements other than onboard cost, wiring cost, and wiring weight may be added to the onboard function and power supply function, or at least one of evaluation elements such as onboard cost, wiring cost, or wiring weight may be excluded.

(3b) The processor 5 and the method thereof described in the present disclosure may be implemented by a dedicated computer that is provided by configuring a processor and memory programmed to execute one or more functions embodied by a computer program. Alternatively, the processor 5 and the method thereof described in the present disclosure may be implemented by a dedicated computer including a processor with one or more dedicated hardware logic circuits. Alternatively, the processor 5 and the method described in the present disclosure may be implemented by one or more dedicated computer, which is configured as a combination of a processor and a memory, which are programmed to execute one or more functions, and a processor which is configured with one or more hardware logic circuits. The computer program may be stored in a computer-readable non-transitory tangible storage medium as instructions to be executed by a computer. The configuration for implementing the functions of each unit included in the processor 5 does not necessarily need to include software, and all the functions may be implemented using one or more hardware circuits.

(3c) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. A part of the configuration of the above embodiments may be omitted as appropriate. At least a part of the configuration in one embodiment may be added to or substituted for the configuration of another embodiment.

(3d) The present disclosure can be implemented by, in addition to the onboard design device 1 described above, various forms such as a system including the onboard design device 1 as a configuration element, a program controlling a computer to function as the onboard design device 1, a non-transitory tangible storage medium such as a semiconductor memory storing the program, and an onboard design method.

1. An onboard design device comprising:
a topology information acquisition unit configured to acquire topology information indicating:
a plurality of onboard candidate positions showing a position where an electronic control unit is mountable on a design target vehicle;
at least one device onboard position showing a position where a peripheral device, which is mounted on the design target vehicle and connected to the electronic control unit, has been mounted; and
a wiring route including a route between the plurality of onboard candidate positions and a route from the device onboard position to the plurality of onboard candidate positions;
an onboard coefficient acquisition unit configured to acquire a coefficient that defines an onboard function and an onboard condition determined according to the design target vehicle, wherein
the onboard function is an objective function used for calculating an evaluation value indicating whether an arrangement of the electronic control unit is desired,
the onboard condition is a constraint that limits a range that a first decision variable and a second decision variable are capable of taking,
the first decision variable represents whether to mount the electronic control unit for each of the plurality of onboard candidate positions, and
the second decision variable represents a connection destination that is the electronic control unit mounted at the plurality of onboard candidate positions and connected for each peripheral device; and
an onboard calculation unit configured to determine an onboard position and an onboard number of the electronic control unit by calculating the first decision variable and the second decision variable that maximize or minimize the evaluation value calculated by the onboard function in a range that satisfies the onboard condition.

2. The onboard design device according to claim 1, wherein
the onboard function is set to calculate, as the evaluation value, an onboard cost determined based on whether to mount the electronic control unit and a total value of a wiring cost between the electronic control unit and the peripheral device.

3. The onboard design device according to claim 1, wherein
the onboard function is set to calculate, as the evaluation value,
a total value of an onboard cost determined based on whether to mount the electronic control unit and a wiring cost between the electronic control unit and the peripheral device and
a weight addition value of a wiring weight between the electronic control unit and the peripheral device.

4. The onboard design device according to claim 1, wherein
the constraint includes a condition that the electronic control unit is mounted at at least one of the plurality of onboard candidate positions and a condition that the peripheral device is connected to at least one of the electronic control unit.

5. The onboard design device according to claim 1, wherein
the topology information is represented by a graph in which the plurality of onboard candidate positions and the device onboard position are a node, and the wiring route is an edge.

6. The onboard design device according to claim 1, further comprising:
a power supply coefficient acquisition unit configured to acquire a coefficient that defines a power supply function and a power supply condition, wherein
the power supply function is an objective function that calculates an evaluation value representing whether a wiring structure of a power line connects an onboard unit is desired using a third decision variable representing whether a wiring of the power line between an onboard unit is present,
the power supply condition is a constraint that limits a range that the third decision variable is capable of taking, and
the onboard unit is the electronic control unit whose onboard position has been determined among the plurality of onboard candidate positions by the onboard calculation unit; and
a power supply calculation unit configured to determine a wiring structure of the power line by calculating the third decision variable that maximizes or minimizes the evaluation value calculated by the power supply function in a range that satisfies the power supply condition.

7. The onboard design device according to claim 6, wherein
the power supply function is set to calculate a wiring cost of a power line connecting the onboard unit as the evaluation value.

8. The onboard design device according to claim 6, wherein
the power supply function is set to calculate a wiring cost of a power line connecting the onboard unit and a weight addition value of a wiring weight of the power line connecting the onboard unit, as the evaluation value.

9. The onboard design device according to claim 6, wherein
the power supply condition includes a condition that a leading unit, which is the onboard unit directly connected to a battery, does not have an input from a non-leading unit, which is the onboard unit different from the leading unit, a condition that the non-leading unit has an input from one of the onboard unit different from itself, and a condition that a link number of a link connecting the onboard unit is less than a node number that is a numerical number of the onboard unit.

10. An onboard design method performed by an onboard design device constructed using a computer, the method comprising causing:
a topology information acquisition unit of the computer to acquire topology information regarding:
a plurality of onboard candidate positions showing a position where an electronic control unit is mountable on a design target vehicle;
at least one device onboard position showing a position where a peripheral device, which is mounted on the design target vehicle and connected to the electronic control unit, has been mounted; and
a wiring route including a route between the plurality of onboard candidate positions and a route from the device onboard position to the plurality of onboard candidate positions;
an onboard coefficient acquisition unit of the computer to acquire a coefficient that defines an onboard function and an onboard condition determined according to the design target vehicle, wherein
the onboard function is an objective function used for calculating an evaluation value indicating whether an arrangement of the electronic control unit is desired,
the onboard condition is a constraint that limits a range that a first decision variable and a second decision variable are capable of taking,
the first decision variable represents whether to mount the electronic control unit for each of the plurality of onboard candidate positions, and
the second decision variable represents a connection destination that is the electronic control unit mounted at the plurality of onboard candidate positions and connected for each peripheral device; and
an onboard calculation unit of the computer to determine an onboard position and an onboard number of the electronic control unit by calculating the first decision variable and the second decision variable that maximize or minimize the evaluation value calculated by the onboard function in a range that satisfies the onboard condition.

11. An onboard design device comprising:
a processor; and
a memory coupled to the processor and storing program instructions that when executed by the processor cause the processor to at least:
acquire topology information indicating:
a plurality of onboard candidate positions showing a position where an electronic control unit is mountable on a design target vehicle;
at least one device onboard position showing a position where a peripheral device, which is mounted on the design target vehicle and connected to the electronic control unit, has been mounted; and
a wiring route including a route between the plurality of onboard candidate positions and a route from the device onboard position to the plurality of onboard candidate positions;
acquire a coefficient that defines an onboard function and an onboard condition determined according to the design target vehicle, wherein
the onboard function is an objective function used for calculating an evaluation value indicating whether an arrangement of the electronic control unit is desired,
the onboard condition is a constraint that limits a range that a first decision variable and a second decision variable are capable of taking,
the first decision variable represents whether to mount the electronic control unit for each of the plurality of onboard candidate positions, and
the second decision variable represents a connection destination that is the electronic control unit mounted at the plurality of onboard candidate positions and connected for each peripheral device; and
determine an onboard position and an onboard number of the electronic control unit by calculating the first decision variable and the second decision variable that maximize or minimize the evaluation value calculated by the onboard function in a range that satisfies the onboard condition.
